(19) United States
(12) Patent Application Publication
(10) Pub. No.: US 2026/0368080 A1
(43) Pub. Date: Nov. 19, 2026

(54) ELECTRONIC DEVICE AND METHOD FOR MANAGING MEMORY

(71) Applicant: MEDIATEK INC., Hsinchu City (TW)

(72) Inventors: Chung-Hsuan TSAI, Hsinchu City (TW); Chung-Jung LEE, Hsinchu City (TW); Chun-Hung WU, Hsinchu City (TW); Li-San YAO, Hsinchu City (TW); Yung-Tien CHU, Hsinchu City (TW); Hsin-Yu WANG, Hsinchu City (TW)

(21) Appl. No.: 19/210,123

(22) Filed: May 16, 2025

(51) Int. Cl. G06F 12/02; G06F 12/123

(52) U.S. Cl. CPC G06F 12/0246; G06F 12/123

(57) ABSTRACT

An electronic device is provided. The electronic device includes a first storage device, a second storage device, and a controller. The controller is configured to determine whether there is an available segment within a first memory address range. The first memory address range corresponds to the first storage device. The controller is further configured to store data into a segment within the first memory address range to store the data into the first storage device, in response to a determination that there is an available segment within the first memory address range. The segment is a continuous memory space with a predefined size.

### BACKGROUND OF THE INVENTION

### Field of the Invention

The present invention relates to memory management, and in particular it relates to a power-saving method for managing memory.

### Description of the Related Art

Power consumption can significantly affect user experience, especially for mobile devices. High power consumption will negatively affect user experience. Reducing power consumption is therefore desirable. On the other hand, some electronic devices intro-duce multiple storage devices to increase the amount of data that can be stored. However, increasing the number of storage devices will cause high power consumption. How to reduce the power consumption of a device with multiple storage devices is a problem that needs to be solved. Furthermore, how to reduce power consumption without substantially increasing the latency in accessing data from the storage devices is also a problem that needs to be solved.

Thus, a memory management method applicable to devices with multiple storage devices is required to reduce power consumption.

### BRIEF SUMMARY OF THE INVENTION

An embodiment of the present disclosure provides an electronic device. The electronic device comprises a first storage device, a second storage device, and a controller. The controller is configured to determine whether there is an available segment within a first memory address range. The first memory address range corresponds to the first storage device. The controller is further configured to store data into a segment within the first memory address range to store the data into the first storage device, in response to a determination that there is an available segment within the first memory address range. The segment is a continuous memory space with a predefined size.

In some embodiments, the controller is further configured to store the data into a segment within a second memory address range to store the data into the second storage device, in response to a determination that there is no available segment within the first memory address range. The second memory address range corresponds to the second storage device.

In some embodiments, the controller is further configured to determine whether there is an old data in a current segment that has to be updated. The controller is further configured to free the old data from the current segment and append a new data into the current segment to complete the update, in response to a determination that there is the old data. In some embodiments, the controller is further configured to determine whether there is a victim segment with invalid data that have not been used over a first threshold of time. The controller is further configured to move the invalid data stored in the victim segment to a current segment to make the victim segment an available segment, in response to a determination that there is the victim segment.

In some embodiments, the controller is further configured to determine whether there is data stored within a second memory address range. The second memory address range corresponds to the second storage device. The controller is further configured to power down the second storage device, in response to a determination that there is no data stored within the second memory address range. In some embodiments, the controller is further configured to control the second storage device to enter a sleep mode, in response to a determination that there is data stored within the second memory address range.

In some embodiments, the first storge device and the second storage device are controlled by a flash-friendly file system (F2FS), and the first storge device and the second storage device are storage devices that use universal flash storage (UFS).

In addition, an embodiment of the present disclosure provides a method for managing memory. The method comprises determining whether there is an available segment within a first memory address range using a controller of an electronic device. The first memory address range corresponds to a first storage device of the electronic device. The method further comprises storing data into a segment within the first memory address range to store the data into the first storage device using the controller, in response to a determination that there is an available segment within the first memory address range.

### BRIEF DESCRIPTION OF THE DRAWINGS

The present invention can be more fully understood by reading the subsequent detailed description and examples with references made to the accompanying drawings, wherein:

FIG. 1 is a block diagram of the electronic device in accordance with embodiments of the present disclosure;

FIG. 2 illustrates the software layer stack in accordance with the embodiments of the present disclosure;

FIGS. 3A and 3B illustrate the operation of the electronic device in accordance with embodiments of the present disclosure;

FIGS. 4A and 4B are flow diagrams of the method for managing memory in accordance with the present disclosure;

FIG. 5 is a flow diagram of the method for managing memory in accordance with the present disclosure; and

FIG. 6 is a flow diagram of the method for managing memory in accordance with the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

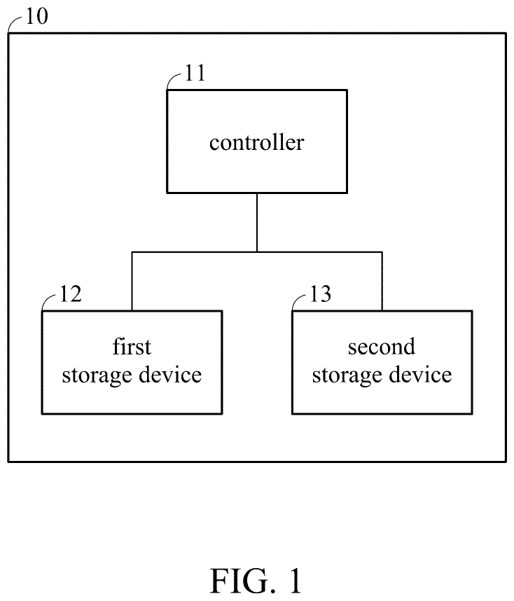

Refer to FIG. 1, FIG. 1 is a block diagram of the electronic device 10 in accordance with embodiments of the present disclosure. For example, the electronic device 10 may be a mobile device, a wearable device, a wireless communication device, or a computing device. In some embodiments, the electronic device 10 is implemented in a smartphone, a smartwatch, a tablet computer, or a notebook computer. The electronic device 10 comprises a controller 11, a first storage device 12, and a second storage device 13.

The controller 11 controls operations of the electronic device 10. The controller 11 provides the required process ability to perform operating systems, programs, software, driver, applications, and functions of the electronic device 10. In some embodiments, the controller 11 is configured to execute application, software, program, and/or driver, so as to the read data from the first storage device 12 and the second storage device 13, write data to the first storage device 12 and the second storage device 13, control the first storage device 12 and the second storage device 13 to enter the sleep mode or power down, and determine the location where the data is stored through these application, software, program, and/or driver. In some embodiments, the controller 11 is configured to perform program (or computer-readable instruction) stored in the electronic device 10. When the program is performed by the controller 11, the program causes the controller 11 to execute the application, software, program, and/or driver, so as to implement methods in accordance with the embodiments of the present disclosure. In some embodiments, the controller 11 may be implemented in the form of hardware with electronic components including transistors, diodes, capacitors, re-sistors, or inductors. These components are configured and arranged to achieve specific purposes in accordance with the embodiments of the present disclosure. In other words, the controller 11 is a special-purpose machine specifically configured to perform specific tasks including in accordance with the embodiments of the present disclosure. The controller 11 may include at least one processor. For example, the controller 11 may include a general purpose micro-processor, the special purpose processor, a central processing unit (CPU), an application processor, and/or related chip set. Different processors may be independent components, or may be integrated into one or more processors.

The first storage device 12 and the second storage device 13 are two independent storage devices. In some embodiments, the first storage device 12 and the second storage device 13 are physically separated. In some embodiments, each of the first storage device 12 and the second storage device 13 can individually be controlled to be activated, enter the sleep mode, and powered down. In other words, the second storage device 13 can be powered down or enter the sleep mode, while the first storage device 12 is activated, vice versa. In some embodiments, the first storage device 12 and the second storage device 13 are storage devices that use (applying) universal flash storage (UFS). In some embodiments, the first storage device 12 and the second storage device 13 comprises memory, flash memory, read only memory (ROM), dynamic random access memory (DRAM), and/or static random access memory (SRAM).

Furthermore, the electronic device 10 may comprise other components which aren't shown in the FIG. 1, such as a display or a touch screen, a battery, an internal power supply, and/or an input-output device.

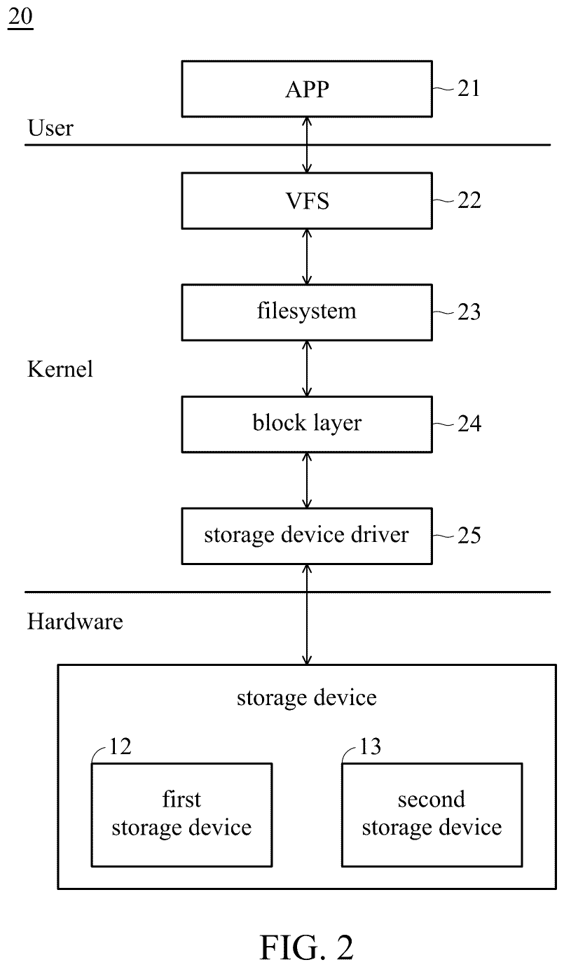

Refer to FIG. 2, FIG. 2 illustrates the software layer stack 20 in accordance with the embodiments of the present disclosure. Software layer stack 20 comprises application 21, virtual filesystem (VFS) 22, filesystem 23, block layer 24, and storage device driver 25. In some embodiments, the controller 11 is configured to execute program so as to implement software layer stack 20. The application 21 may generate data and write the data into the first storage device 12 and the second storage device 13. The application 21 may read data stored in the first storage device 12 and the second storage device 13. VFS 22 provides a general in-terface between user and filesystem 23. The filesystem 23 is configured to manage and or-ganize data on the first storage device 12 and the second storage device 13. The filesystem 23 is configured to separate the memory space of the first storage device 12 and the second storage device 13 into multiple parts (e.g. memory segments) with fixed size. The filesystem 23 is configured to store data (e.g. a file) into one or more segment. When the application 21 requires to read/write a certain file, the filesystem 23 is configured to access/write one or more segments at certain address. This allows the application 21 to read/write data without knowing where the data is stored. The filesystem 23 is configured to move and release the data stored in the first storage device 12 and the second storage device 13. In some embodiments, the filesystem 23 is a flash-friendly file system (F2FS), and the first storge device 12 and a second storage device 13 are controlled by the F2FS. The block layer 24 is configured to manage the transfer of data. In some embodiments, the block layer 24 is configured to bypass the data. The storage device driver 25 interfaces directly with the first storage device 12 and the second storage device 13 and allows upper layer to control and communicate with the first storage device 12 and the second storage device 13. The storage device driver 25 is configured to turn on, power down the first storage device 12 and the second storage device 13 or control the first storage device 12 and the second storage device 13 to enter the sleep mode. In some embodiments, the storage device driver 25 is UFS driver.

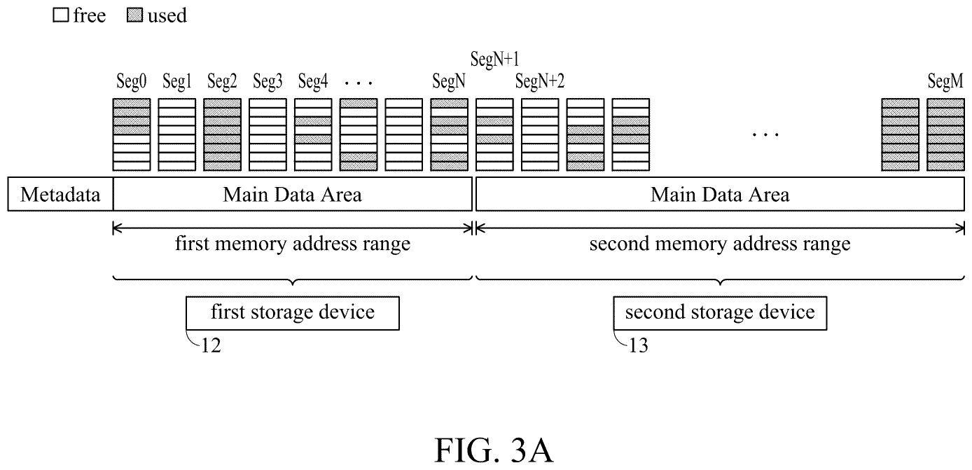

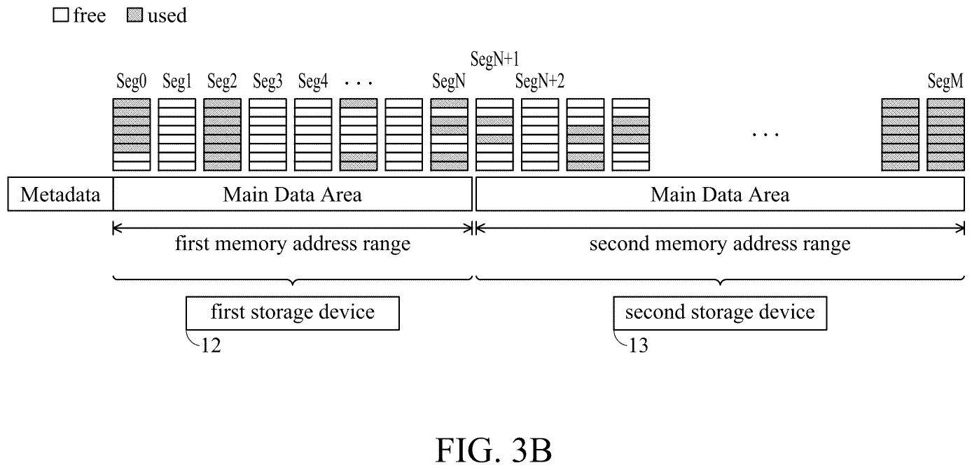

Refer to FIGS. 3A and 3B, FIGS. 3A and 3B illustrate the operation of the electronic device 10 in accordance with embodiments of the present disclosure. The memory space of the first storage device 12 and the second storage device 13 is separated into multiple segments (memory segment). In this embodiment, the memory space of the first storage device 12 and the second storage device 13 is separated into segments Seg0~SegM. In some embodiments, each of the segments Seg0~SegM may be further separated into multiple blocks. Each of the segments Seg0~SegM is a continuous memory space with a predefined size (e.g. 2 MB). Each of the segments Seg0~SegM may correspond to (have) a range of memory address, which is continuous. The memory address of segments Seg0~SegN are within the first memory address range, and the memory address of segments SegN+1~SegM are within the second memory address range. The first memory address range and the second memory address range respectively comprises continuous memory addresses. For example, the first memory address range is 1~100,and the second memory address range is 101~200. The first memory address range corresponds to the first storage device 12, and the second memory address range corresponds to the second storage device 13. In other words, the data stored in the memory address within the first memory address range is stored in the first storage device 12, and the data stored in the memory address within the second memory address range is stored in the second storage device 13.

The filesystem 23 (i.e. the controller 11) selects one segment from the segments Seg0~SegM with lowest LBA (Logical Block Addressing) as current segment. When there is new data which has to be written into the first storage device 12 and the second storage device 13, the filesystem 23 (i.e. the controller) stores the data in the current segment. The data stored in the first storage device 12 and the second storage device 13 cannot be over-written. Thus, when the data stored in the first storage device 12 and the second storage device 13 has to be updated, the filesystem 23 frees the old data (may be stored in the segment other than the current segment) and write the new data into the current segment. In some embodiments, the filesystem 23 labels the old data as invalid when the old data has not been used over a first threshold of time. The filesystem 23 periodically performs the garbage collection. The filesystem 23 periodically looks for one segment with invalid data from the segments Seg0~SegM as victim segment. The filesystem 23 moves the data stored in the victim segment to the current segment so as to free the memory space of the victim segment. As shown in FIGS. 3A, 3B, the segment Seg4 is selected as the victim segment, and the segment Seg0 is selected as the current segment. After the garbage collection, as shown in FIG. 3B, the data stored in the segment Seg4 has moved to the segment Seg0 such that the segment Seg4 becomes an empty segment.

When the current segment is full and cannot store data, the filesystem 23 selects another segment as the current segment using a round robin strategy. Specifically, the filesystem 23 selects the segment next to the current segment as the next current segment. When the current segment is the last segment, the filesystem 23 selects the first segment as the next current segment. For example, when the segment seg0 is the current segment, the filesystem 23 selects segment seg1 as the next current segment. When the segments seg1 is the current segment, the filesystem 23 selects segment seg2 as the next current segment. When the segment segN is the current segment, the filesystem 23 selects segment segN+1 as the next current segment. When the segment segM is the current segment, the filesystem 23 selects segment seg1 as the next current segment.

Operating two storage devices increases the power consumption. The first storage device 12 and the second storage device 13 can be powered down or enter sleep mode. Com-paring to resuming from the power down state, it takes a relatively long time for the first storage device 12 and the second storage device 13 to resume from the power down state. However, the first storage device 12 and the second storage device 13 still consume power in the sleep mode. Thus, letting the first storage device 12 and the second storage device 13 enter sleep mode cannot address the power consumption issue. On the other hand, power down the first storage device 12 and the second storage device 13 may decrease the power consumption. However, it takes a long time for the first storage device 12 and the second storage device 13 to resume from power down state. Thus, it takes a long time to read/write data from/into the powered down storage device. This will cause the overall latency to be increased. Because of the round robin strategy, the data is uniformly stored in the first storage device 12 and the second storage device 13, and both of the first storage device 12 and the second storage device 13 are likely to be accessed. Thus, it is hard to power down one of the first storage device 12 and the second storage device 13 to lower the power consumption without negatively impacting the latency.

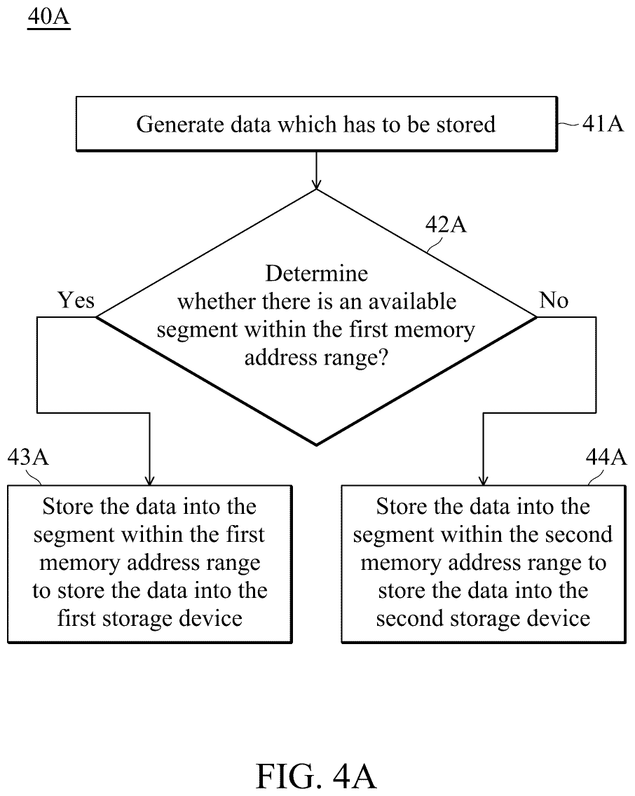

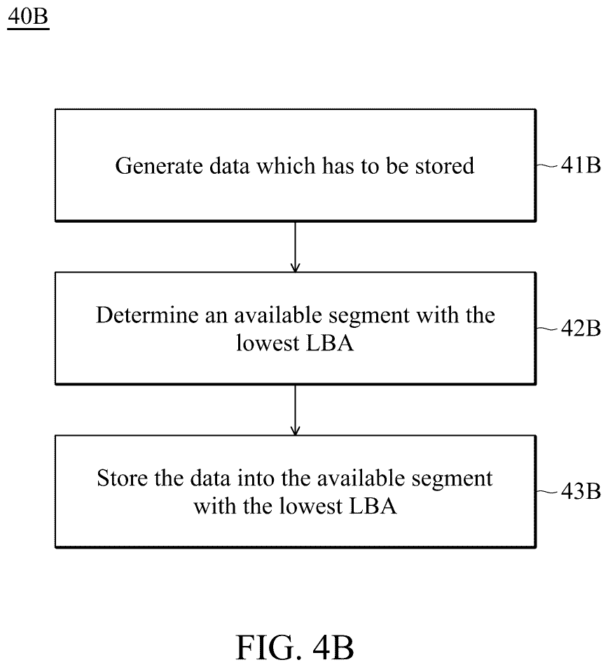

Embodiments of the present disclosure can reduce the power consumption without substantially increase the latency. Refer to FIG. 4A, FIG. 4A is a flow diagram of the method 40A for managing memory in accordance with the present disclosure. In operation 41A, the controller 11 generates (or receives) data which has to be stored. For example, the application 21 generates data, and the filesystem 23 receives the data from the application 21. In operation 42A, the controller 11 determines whether there is an available segment within the first memory address range. In some embodiments, the controller 11 is configured to determine whether any one of the segments Seg0~SegN is able to store the data. For example, the controller 11 determines whether any one of the segments Seg0~SegN is empty (i.e. doesn't store any data) and thus is able to store the data. Alternatively, the controller 11 may determine whether any one of the segments Seg0~SegN has already stored some data but still has the space to store the data (i.e. has already stored some data but is still able to store data). In response to a determination that there is an available segment within the first memory address range, the controller 11 performs operation 43A. In response to a determination that there is no available segment within the first memory address range, the controller 11 performs operation 44A.

In operation 43A, the controller 11 (the filesystem 23) stores the data into the segment within the first memory address range to store the data into the first storage device 12. The data is stored in the available segment found in operation 42A. In operation 44A, the controller 11 (the filesystem 23) stores the data into the segment within the second memory address range to store the data into the second storage device 13. Based on the description above, data is stored in the first storage device 12, whenever the first storage device 12 is able to store the data. Data is stored in the second storage device 13 only when the first storage device 12 isn't able to store the data. In this way, the data is centrally placed on the first storage device 12, rather than uniformly placed on the first storage device 12 and the second storage device 13. Generally speaking, the filesystem 23 doesn't know which device (the first storage device 12 and the second storage device 13) the data is stored in. The filesystem 23 can only know the logical block address of the data. Embodiments of the present disclosure enables the controller 11 (the filesystem 23) to store the data on a certain device by searching the available segment within the predefined address range (e.g. the first memory address range).

Refer to FIG. 4B, FIG. 4B is a flow diagram of the method 40B for managing memory in accordance with the present disclosure. In operation 41B, the controller 11 generates (or receives) data which has to be stored. For example, the application 21 generates data, and the filesystem 23 receives the data from the application 21. In operation 42B, the controller 11 determines an available segment with the lowest LBA. In some embodiments, the controller 11 is configured to determine whether any one of the segments Seg0~SegM with the lowest LBA is able to store the data. In other words, the controller 11 looks for the available segment from all the segments, instead of the segments Seg0~SegN. For example, the controller 11 identify one empty segments with the lowest LBA from the segments Seg0~SegM. Alternatively, the controller 11 may determine whether any one of the segments Seg0~SegM with the lowest LBA has already stored some data but still has the space to store the data being requested (i.e. has already stored some data but is still able to store data being requested). In operation 43B, the controller 11 stores the data into the available segment with the lowest LBA (i.e. the available segment found in operation 42B). Since the controller 11 always look for an available segment with the lowest LBA, the segments Seg0~SegN in the first storage device 12 is prioritized over the segments SegN+1~SegM in the second storage device.

Based on the description above, data is prioritized to be stored in the first storage device 12, whenever the first storage device 12 is able to store the data. Data is stored in the second storage device 13 only when the first storage device 12 isn't able to store the data. Thus, the data is also centrally placed on the first storage device 12, rather than uniformly placed on the first storage device 12 and the second storage device 13. As described above, the filesystem 23 doesn't know which device (the first storage device 12 and the second storage device 13) the data is stored in. The filesystem 23 can only know the LBS of the data. Embodiments of the present disclosure enables the controller 11 (the filesystem 23) to store the data on a certain device by searching the available segment with the lowest LBS.

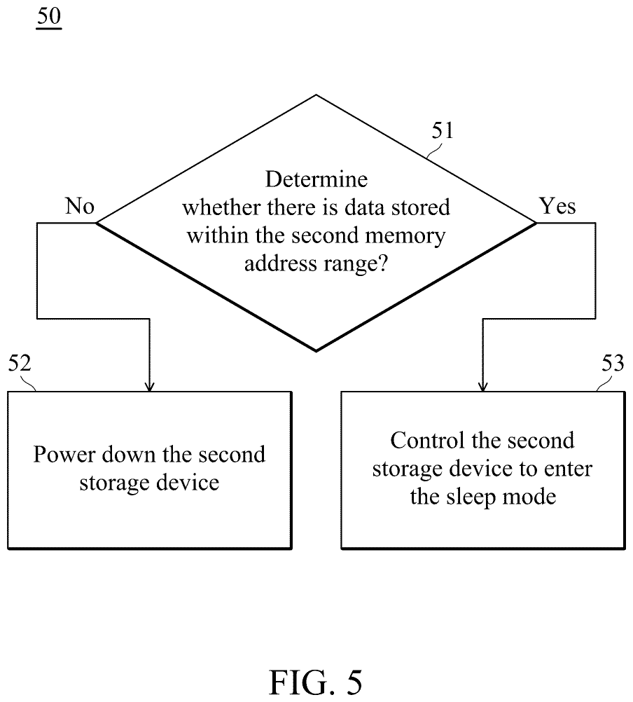

Refer to FIG. 5, FIG. 5 is a flow diagram of the method 50 for managing memory in accordance with the present disclosure. In operation 51, the controller 11 (the filesystem 23) determines whether there is data stored within the second memory address range. In response to a determination that there is no data stored within the second memory address range, the controller 11 performs operation 52. In response to a determination that there is data stored within the second memory address range, the controller 11 performs operation 53. In operation 52, the controller 11 (the storage device driver 25) powers down the second storage device 13. In operation 53, the controller 11 (the storage device driver 25) controls the second storage device 13 to enter the sleep mode.

In other words, the controller 11 (the filesystem 23) determines whether the second storage device 13 stores data. When the second storage device 13 doesn't store any data, the controller 11 powers down the second storage device 13 to save power. Because there's no data stored in the second storage device 13, there's no need to access the second storage device 13, and powering down the second storage device 13 won't affect the latency. When the second storage device 13 stores data, the controller 11 controls the second storage device 13 to enter the sleep mode, for example, while the When the second storage device 13 doesn't store any data, the controller 11 controls the second storage device 13 to enter the sleep mode, for example, while the second storage device 13 is idle. Entering the sleep mode rather than being powered down can reduce the latency. Again, the filesystem 23 can only know the logical block address of the data. Embodiments of the present disclosure enables the controller 11 (the filesystem 23) to determine which device is the data stored in by determining whether data is stored in the predefined address range (e.g. the second memory address range).

In some embodiments, in response to a determination that there is data stored within the second memory address range and there is an available segment within the first memory address range, the controller 11 stores data into the segment within the first memory address range to store the data into the first storage device 12. In response to a determination that there is data stored within the second memory address range and there is no available segment within the first memory address range, the controller 11 stores data into the segment within the second memory address range to store the data into the second storage device 13. In other words, even when the second storage device 13 stores data, the controller 11 still uses the method 40 to determine which device should the data be stored in. In this way, most of the data is stored in the first device 12. The frequency to access the second storage device 13 is reduced, and the second storage device 13 can stay in the sleep mode for a long time. Thus, the power consumption is reduced.

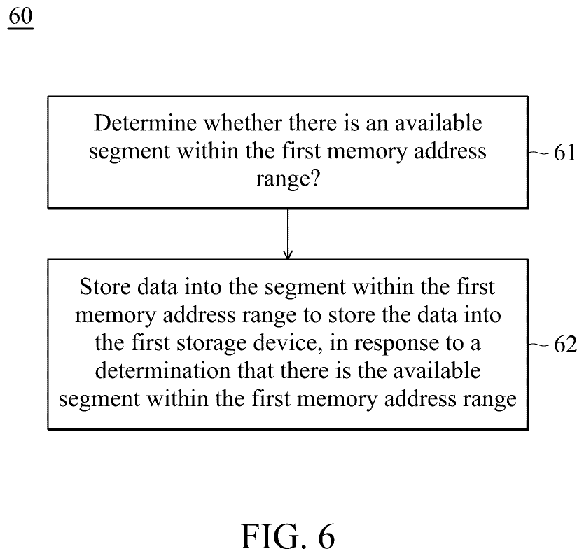

Refer to FIG. 6, FIG. 6 is a flow diagram of the method 60 for managing memory in accordance with the present disclosure. In operation 61, the controller 11 (the filesystem 23) determines whether there is an available segment within the first memory address range. In operation 62, the controller 11 (the filesystem 23) stores data into the segment within the first memory address range to store the data into the first storage device 12, in response to a determination that there is an available segment within the first memory address range.

Embodiments of the present disclosure can store the data centrally in the same device. The other device which doesn't store data can be powered down to reduce power consumption. Furthermore, powering down the device which doesn't store data has little im-pact on the latency. Thus, embodiments of the present disclosure can reduce the power consumption while maintaining low latency.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
a first storage device;
a second storage device; and
a controller, configured to:
determine whether there is an available segment within a first memory address range, wherein the first memory address range corresponds to the first storage device; and
in response to a determination that there is an available segment within the first memory address range, store data into a segment within the first memory address range to store the data into the first storage device, wherein the segment is a continuous memory space with a predefined size.

2. The electronic device as claimed in claim 1, wherein the controller is further configured to:
in response to a determination that there is no available segment within the first memory address range, store the data into a segment within a second memory address range to store the data into the second storage device, wherein the second memory address range corresponds to the second storage device.

3. The electronic device as claimed in claim 1, wherein the controller is further configured to:
determine whether there is an old data in a current segment that has to be updated; and
in response to a determination that there is the old data, free the old data from the current segment and append a new data into the current segment to complete the update.

4. The electronic device as claimed in claim 1, wherein the controller is further configured to:
determine whether there is a victim segment with invalid data that have not been used over a first threshold of time; and
in response to a determination that there is the victim segment, move the invalid data stored in the victim segment to a current segment to make the victim segment an available segment.

5. The electronic device as claimed in claim 1, wherein the controller is further configured to:
determine whether there is data stored within a second memory address range, wherein the second memory address range corresponds to the second storage device; and
in response to a determination that there is no data stored within the second memory address range, power down the second storage device.

6. The electronic device as claimed in claim 5, wherein the controller is further configured to:
in response to a determination that there is data stored within the second memory address range, control the second storage device to enter a sleep mode.

7. The electronic device as claimed in claim 1, wherein the first storge device and the second storage device are controlled by a flash-friendly file system (F2FS), and the first storge device and the second storage device are storage devices that use universal flash storage (UFS).

8. A method for managing memory, comprising:
determining, via a controller of an electronic device, whether there is an available segment within a first memory address range, wherein the first memory address range corresponds to a first storage device of the electronic device; and
storing, via the controller, data into a segment within the first memory address range to store the data into the first storage device, in response to a determination that there is an available segment within the first memory address range;
wherein the segment is a continuous memory space with a predefined size.

9. The method as claimed in claim 8, further comprising:
determining, via the controller, whether there is an old data in a current segment that has to be updated; and
freeing, via the controller, the old data from the current segment and append a new data into the current segment to complete the update, in response to a determination that there is the old data.

10. The method as claimed in claim 8, further comprising:
determining, via the controller, whether there is a victim segment with invalid data that have not been used over a first threshold of time; and
moving, via the controller, the invalid data stored in the victim segment to a current segment to make the victim segment an available segment, in response to a determination that there is the victim segment.

11. The method as claimed in claim 8, further comprising:
storing, via the controller, the data into a segment within a second memory address range to store the data into a second storage device of the electronic device, in response to a determination that there is no available segment within the first memory address range;
wherein the second memory address range corresponds to the second storage device.

12. The method as claimed in claim 8, further comprising:
determining, via the controller, whether there is data stored within a second memory address range, wherein the second memory address range corresponds to a second storage device of the electronic device; and
powering down, via the controller, the second storage device, in response to a determination that there is no data stored within the second memory address range.

13. The method as claimed in claim 12, further comprising:
controlling, via the controller, the second storage device to enter a sleep mode, in response to a determination that there is data stored within the second memory address range.

14. The method as claimed in claim 8, wherein the first storge device and a second storage device of the electronic device are controlled by a flash-friendly file system (F2FS), and the first storge device and the second storage device are storage devices that use universal flash storage (UFS).
